(19) United States
(12) Patent Application Publication
(10) Pub. No.: US 2025/0165726 A1
(43) Pub. Date: May 22, 2025

(54) METHOD FOR TRANSLATING USER REQUESTS INTO PLANNING PROBLEMS USING INTERMEDIATE REPRESENTATIONS

(71) Applicant: Intuit Inc., Mountain View, CA (US)

(72) Inventors: Anu SREEPATHY, Sunnyvale, CA (US); Sudhir AGARWAL, Palo Alto, CA (US)

(21) Appl. No.: 18/954,409

(22) Filed: Nov. 20, 2024

Related U.S. Application Data
(60) Provisional application No. 63/601,622, filed on Nov. 21, 2023.

(51) Int. Cl. G06F 40/49; G06F 40/35

(52) U.S. Cl. CPC G06F 40/49; G06F 40/35

(57) ABSTRACT

Certain aspects of the disclosure provide techniques for translating a user request (e.g., posed in natural language) into a structured input using intermediate representations, to resolve the user request as a planning problem. A method generally includes generating a first intermediate representation of a first user request using a large language model (LLM), wherein the first intermediate representation comprises one or more first facts and/or one or more rules in a declarative language; generating a first materialized representation of the first user request based on the first intermediate representation and a domain description using a logic reasoner, wherein the first materialized representation comprises one or more second facts in the declarative language, and wherein the one or more second facts comprise a subset of the one or more first facts and one or more inferred facts; and generating a task description based on the first materialized representation.

### CROSS-REFERENCE TO RELATED APPLICATION

This Application claims the benefit of and priority to U.S. Provisional Patent Application No. 63/601,622, filed on Nov. 21, 2023, the entire contents of which are hereby incorporated by reference.

### BACKGROUND

### Field

Aspects of the present disclosure relate to techniques for translating a user request (e.g., posed in natural language) into a structured planner input using intermediate representations, to resolve the user request as a planning problem.

### Description of Related Art

A prompt is a specific instruction and/or request, posed in natural language, given to a computer program and/or language model to perform a particular task and/or generate a specific output. For example, in some cases, prompts include one or more user requests (e.g., questions, queries, commands) and are provided as input to a computer program and/or language model to instruct the computer program and/or language model to resolve and/or respond to the one or more user requests. A prompt may consist of terms or phrases spoken normally and/or entered as they might be spoken, without any special format and/or alteration of syntax. In some cases, prompts are generated through a text and/or voice interface.

In the context of natural language processing (NLP) and machine learning, prompts are often used to guide large language models (LLMs) in generating output, such as text. In particular, an LLM is a type of machine learning model that can perform a variety of NLP tasks, such as generating and classifying text, answering prompts in a conversational manner, and translating text from one language to another. NLP makes it possible for software to “understand” typical human speech or written content as an input into an LLM-based system and to respond to it by, in some cases, generating human-understandable responses through natural language generation (NLG).

A popular LLM, which has gained much recent attention, includes a generative pre-trained transformer (GPT) model. A GPT model is a specific type of LLM based on a transformer architecture (e.g., architecture that uses an encoder-decoder structure and does not rely on recurrence and/or convolutions to generate an output), that is pre-trained in a generative and unsupervised manner (e.g., it learns from data without being given explicit instructions on what to learn). A GPT model analyzes prompts and predicts the best possible response based on their understanding of the language. In particular, the GPT model may rely on the knowledge it gains after its, in some cases, billions or even trillions of parameters, are trained on massive datasets.

While LLMs, such as GPT models, represent a transformative force in many industries by enabling developers to build conversation-driven applications for prompt processing and answering, these models are not without limitation. For example, while a powerful tool, a general-purpose LLM is only as good as the underlying, publicly-available training data used to train the model. This presents a technical problem in cases where the knowledge artifacts necessary for accurately responding to a prompt are partly, or completely, internal to an organization. For example, a general-purpose LLM trained on publicly-available data, while vast, may not be able to respond, or may respond incorrectly, to a prompt requesting information about employee retention at a particular company for a previous year, given that this information is internal and confidential to the company (e.g., not publicly available, and thus not used to train the LLM).

### SUMMARY

Certain aspects provide a method of user request translation. The method generally includes generating a first intermediate representation of a first user request included in a first prompt using a large language model (LLM), wherein the first user request requests a state change from an initial state to a desired goal state, and wherein the first intermediate representation comprises at least one of: one or more first facts, or one or more rules in a declarative language; generating a first materialized representation of the first user request based on the first intermediate representation and a domain description using a logic reasoner, wherein the first materialized representation comprises one or more second facts in the declarative language, and wherein the one or more second facts comprise a subset of the one or more first facts and one or more inferred facts; and generating a task description based on the first materialized representation, wherein the task description comprises structured input for a planner.

Certain aspects provide a method of plan generation. The method generally includes receiving a task description associated with a first user request, wherein: the first user request requests a state change from an initial state to a desired goal state, and the task description comprises structured input for a planner and is based on a materialized representation comprising one or first facts in a declarative language that are associated with an intermediate representation of the first user request comprising at least one of: one or more second facts, or one or more rules in the declarative language; and generating an execution plan based on at least the task description, wherein the execution plan comprises a sequence of steps used to transform the initial state to the desired goal state

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1A depicts an example system for processing and answering user requests as planning problems.

FIG. 1B depicts an example problem when using a large language model to translate a user request into a structured language to resolve the user request as a planning problem.

FIGS. 1C-1D depict example implementations for translating a user request into a planning problem using intermediate representations.

FIGS. 2A-2F depict example user request translation using intermediate representations.

FIG. 3 depicts an example method for user request translation.

FIG. 4 depicts an example method for plan generation.

FIG. 5 depicts an example processing system with which aspects of the present disclosure can be performed.

Additional aspects of the present disclosure can be found in the attached appendix.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

To address the shortcomings of general-purpose LLMs, some conventional approaches seek to combine and orchestrate LLM functionality with other sources of computation and/or knowledge. For example, some conventional approaches focus on using an LLM as a planner, by interfacing LLMs with organization-specific application programming interface(s) (API(s)) (e.g., mechanisms that enable at least two software components to communicate with each other using a set of definitions and protocols) and/or other tool(s). For instance, the LLM, acting as a planner, may be configured to perform similar functions as a planner used to solve classical artificial intelligence (AI) planning (also referred to as “classical planning” or simply “planning”) problems. Specifically, classical AI planning is the problem of finding a sequence of actions, e.g., an “execution plan” or simply a “plan,” for achieving a goal state from an initial state assuming that actions have deterministic effects.

For example, a user request, included in a prompt that is received by a planner, may be (1) an information-seeking user request requesting a state change from an initial state to a desired goal state, based on information retrieval of general and/or domain-specific data (e.g., desired goal state is the possession of information), (2) a task-oriented user request requesting a state change from an initial state to a desired goal state, based on the completion of one or more tasks excluding information retrieval, or (3) a combination of both (e.g., requesting information retrieval and the performance of one or more other tasks). For example, an information-seeking user request may be a user request requesting information about an organization's sales for the past month (e.g., “Please provide Organization's X's sales for January 2023”), a user request requesting information about employee turnover statistics for an organization, a user request requesting information about potential areas for organization development, and/or the like. On the other hand, task-oriented user requests may include user requests requesting to perform one or more tasks, such as sending an email (e.g., “Send an event email to JaneDoe@gmail.com”), publishing a document, drafting an invoice and sending the invoice to a client, and/or the like. Further, an example information-seeking and task-oriented prompt user request may be, for example, “Send customer Jane Doe the invoice for 5 cakes for $125 on Sep. 30, 2023,” given that information about Jane Doe, her email, the cake, etc. need to be retrieved prior to performing other tasks (e.g., generating the invoice, sending the email, etc.) to reach the goal state.

LLMs as planners, used to solve classical AI planning problems, are responsible for (1) identifying a sequence of actions to reach a desired goal state indicated by an information seeking and/or task-oriented user request (e.g., provided to the LLM as part of a prompt) and (2) orchestrating the execution of those actions. Specifically, by integrating an LLM with organization-specific API(s) and/or tool(s) such that the LLM is able to act as a planner, organizations can create a system where users of the organization can generate a user request as a question, an instruction, a request, etc. in natural language. The LLM can interpret the user request, interact with the necessary API(s) and/or tool(s) to retrieve data internal to the organization, manipulate the data, and/or perform other non-information retrieval tasks, and provide a response to the user request in a user-friendly manner.

Information-seeking and/or task-oriented user requests specific to an organization may require the use of multiple APIs and/or tools associated with the organization to resolve these user requests (e.g., reach the desired goal states). For example, information needed for responding to an information-seeking user request may be stored in multiple databases created for the organization. Thus, the actions identified by an LLM to reach the desired goal state may include many API calls and/or database calls to the different databases to retrieve the necessary/requested information. Similarly, with task-oriented user requests, not only are APIs and/or tools used to obtain information, but communication with other APIs and/or tools for performing various actions beyond information-retrieval are necessary to transition from an initial to a desired goal state set forth in the user request.

For example, a user request (e.g., included as part of a prompt provided to an LLM) may request to “Send an invoice to my client for the cake I baked last week and follow up weekly until my client has paid.” To respond to and resolve this user request, thereby reaching the desired goal state indicated by the user request (e.g., reach a state where the invoice has been sent and weekly reminders have been and/or are currently being carried out), multiple APIs may be needed to obtain information about who the client is, how much each ingredient for the cake costs to determine the total cost of the cake, the client's contact information, the client's preferences for communication, etc. Further, additional APIs may be needed to carry out tasks such as creating the invoice, creating a medium for transmitting the invoice (e.g., an email), sending reminder notifications, etc. As such, the LLM may need to interface with multiple APIs (and/or other tools) of the organization to resolve the single user request. An LLM, however, may only be capable of interfacing with a limited number of specifically designed APIs and/or tools, and thus may not be able to resolve the user request.

In particular, a technical problem associated with the use of existing LLMs configured to interface with APIs and/or tools is their inability to scale beyond, for example, a limited and specific set of APIs and/or tools. This is especially problematic where a standard business organization has hundreds or thousands of APIs, applications, and/or tools in place. For example, existing API/tool-augmented LLMs are limited to connect with a small number of specially designed tools/APIs. For instance, Toolformer™, an API/tool-augmented LLM, created by Meta Platforms, Inc. (doing business as Meta™, and formerly named Facebook®, Inc.) of Menlo Park, California, is trained to use only five different tools: a question-answering API, a Wikipedia search engine, a machine translation system, a calculator, and a calendar. As another example, Chameleon™ is an LLM-based planner that assembles a sequence of tools, among a set of fifteen total tools, to execute and generate a final response. Thus, the potential for connecting LLMs with a large number of APIs, and specifically a large number of domain-specific APIs and/or tools that may be constantly changing, remains under-explored and challenging. For example, while LLMs may be fine-tuned/trained to use multiple APIs and make specific API calls, fine-tuning/training such LLMs is a costly exercise. Additionally, when there are overlapping functionalities in the available APIs, the LLM might not always be able to select the correct API. The reason for this is that the LLM treats the API selection as a classification problem and tries to find a close match, which may not always be the correct choice. In other words, LLMs are based on probabilistic generation of output based on input. As a result, LLM-generated plans, especially in presence of a large number of APIs, are frequently wrong.

Another technical problem with using LLMs (e.g., where the LLM is configured to act as a planner) for solving domain-specific user requests, and more specifically domain-specific, task-oriented user requests, relates to the non-deterministic nature of such models. Specifically, LLMs predict the probability of a word or token given the context represented by a sample of words. The randomness in LLMs typically comes from the sampling methods used during text generation, such as top-k sampling and/or nucleus sampling. As a result, identical requests may yield completely different responses and/or resolutions in different requests. This non-determinism (i.e., this inconsistency in the responses generated in different requests with identical prompts) affects the accuracy, and thus reliability, of responses produced by these LLMs. For example, when using the LLM as a planner to solve the same information-seeking user request or the same task-oriented user request different times, different execution plans may be generated due to the non-determinism of the model.

Embodiments described herein overcome the aforementioned technical problems and improve upon the state of the art by providing a system, including an LLM, a logic reasoner, a standalone classical AI planner (simply referred to herein as a “planner”), and an execution component, configured to process and answer user requests as planning problems. Specifically, the system processes a user request as a planning problem by (1) leveraging the combined capabilities of the LLM and the logic reasoner to translate the user request into a structured input for the planner, such as a task description in planning domain definition language (PDDL) (described further below), (2) leveraging capabilities of the planner to generate an execution plan for the task description, where the execution plan involves the interaction with one or more domain-specific APIs and/or tools, (3) leveraging the execution component to carry out the execution plan to resolve the user request, and (4) again leveraging the LLM to generate a human-understandable response, through NLG, in response to the user request and based on the output of executing the execution plan.

PDDL is the standardized language for expressing planning tasks. PDDL divides the description of a planning task into (1) a domain description and (2) a task description. In the domain description, invariant rules of a world model, like object types, predicates, and possible actions that may be performed, are described. The task description is based on the domain description and describes one concrete task/problem (e.g., a “planning problem”), specifying the objects which are part of the task/problem, an initial state, and the desired goal state that is to be achieved.

Embodiments described herein enable translating a natural language user request into a structured formal language (e.g., a structured plan-oriented language, such as PDDL, structured query language (SQL), Python code, SPARQL protocol and resource description framework (RDF) query language (SPARQL), and/or the like), using intermediate representations, to facilitate planning for task execution (e.g., by the planner). In particular, an LLM may be prompted to generate an intermediate representation of the user request (e.g., provided with a prompt including the user request instructing the LLM to generate the intermediate representation of the user request) and a logic reasoner may be used to generate a materialized representation of the user request prior to generating a task description (e.g., in the PDDL), where the task description is a resulting translation of the user request into structured input to facilitate execution plan generation by the planner to resolve and respond to the user request. As used herein, a logic reasoner is a piece of software whose primary goal is to infer information or knowledge by performing logical inference on the information and knowledge available to the logic reasoner in an appropriate structured format. For example, the logic reasoner may infer new facts from facts and rules included in the intermediate representation generated by the LLM for a user request and in a domain description to expand and rectify the intermediate representation into a materialized representation that contains only facts. The facts included in the materialized representation may include a subset (e.g., one or more) of the facts included in the intermediate representation of the user requests and/or one or more facts inferred by the logic reasoner.

Although an LLM alone may be capable of modeling user requests, with structural and/or language variations, as task descriptions in a structured formal language, LLM techniques for generating such task descriptions may not always guarantee correct task description generation. The reason for this inaccuracy may be due to the LLM's inability to (1) understand the semantic relationships between different words and/or phrases (e.g., tokens) included in a prompt, (2) understand the semantics of the output plan-oriented language (e.g., PDDL) and/or (3) understand the relationships between concepts, the rules, and/or the constraints included in a domain description (e.g., which the task description is based on, as described above). Further, the non-deterministic nature of the LLM may contribute to generating incorrect task descriptions in a structured formal language. As such, to overcome the technical problems associated with using LLMs to translate user requests into task descriptions, embodiments herein propose using both an LLM and a logic reasoner to generate the task descriptions in structured formal language for various prompts.

For example, a prompt received by the LLM and comprising a user request requesting a state change from an initial state to a desired goal state, may instruct the LLM to generate an intermediate representation for the user request. For example, the LLM may receive a prompt stating “I want you to create an intermediate representation of a User Request X,” where User Request X is the user request requesting the state change from the initial state to the desired goal state. The intermediate representation of the user request generated by the LLM, based on receiving the prompt, may capture the fact(s) (e.g., predicate expressions that make declarative statements) and rule(s) (e.g., predicate expressions that use logical implication to describe relationships among facts) (and, in some cases, constraint(s)) mentioned in the user request. In other words, the intermediate representation generated by the LLM may consist of only base information in the user request, where base information is information that cannot be derived from any other information.

The intermediate representation generated by the LLM may then be used by a logic reasoner to generate a materialized representation of the user request. A task description is then generated based on the materialized representation. For example, in some cases, the materialized representation is mapped to the task description based on some generic coding. Alternatively, in some other cases, the LLM is again prompted to generate a task description based on the materialized representation generated for the user request. The resulting translation of the user request into the task description may be provided to a planner to facilitate execution plan generation to resolve and respond to the user request.

The embodiments described herein provide significant technical advantages over conventional approaches. In particular, having an LLM interact with a separate planner, as opposed to having an LLM act as an imperfect planner, to process and answer user requests as planning problems enables the system described herein to leverage the strengths specific to the LLM and the strengths specific to the planner, which avoids the classical jack of all trades, master of none, problem.

For example, planners are tools proven to be useful in generating accurate and optimal plans for planning problems, and orchestrating the execution of these plans, for example, by leveraging a large number of domain-specific APIs and/or tools. In particular, planning requires understanding the domain description and reasoning over the available APIs and their functionality. Thus, by using a planner in combination with an LLM, the need to train an LLM to infer and interact with an appropriate sequence of API(s) and/or tool(s) needed for processing and answering a prompt is eliminated (e.g., thereby decreasing training time and resources, reducing model size, and allowing for easier integration of new APIs and/or changed APIs (e.g., avoiding re-training of the entire LLM), among other advantages). Instead, the planner is leveraged for this functionality, and thus, the system is able to exploit a large number of domain-specific APIs and/or tools. Accordingly, the system described herein is an improved, scalable system that provides a user request processing and answering solution for many domains (e.g., organizations), irrespective of the number of APIs and/or tools specific to those domains. In other words, the system may be capable of processing domain-specific information seeking user request and domain-specific task-oriented user requests that may require the use of many APIs and/or tools.

Further, by configuring the system to use a planner, as opposed to an LLM acting as a planner in conventional implementations, actions carried out and/or information provided in response to the user request may be more accurate, such as to better resolve the user's request. In particular, a planner is known to be more deterministic in nature than an LLM. As such, the planner may behave in a more well-defined and predictable manner than the LLM when generating an execution plan, to therefore reduce inconsistency in execution plan generation for a same user request. Additionally, the use of a standalone planner offers a solution that helps reduce, if not eliminate, the generation of erroneous and/or nonsensical execution plans (e.g., referred to as “hallucinations”) known to be more frequently generated when using LLMs as planners in conventional implementations. The reduction in inconsistency across similar user requests, as well as the reduction (or elimination) of erroneous and/or nonsensical execution plans, leads to a more reliable and trustworthy system with user request processing and answering functionality.

A planner, however, is generally designed to solve problems represented in a structured formal language, such as PDDL, and thus, may not be able to process a user request in natural language. Accordingly, the system described herein leverages the language capabilities of LLMs and the reasoning capabilities of logic reasoners to enable the system to comprehend, process, and respond to any user request received as input. In particular, LLMs, such as GPTs, and logic reasoners have the capability to very effectively act on natural language requests, and in aspects described herein, to translate such natural language requests to formatted output suitable as an input to a planner. As such, the system, including an LLM and a logic reasoner in combination with a planner, is more adept to solving a wider range of user request, including unstructured and/or incomplete user requests, which is a current limitation of existing classical AI planning systems. Further, the system, including the LLM in combination with the logic reasoner, is capable of producing more accurate task descriptions that may be (as opposed to only the LLM generating the task descriptions) provided as input to the planer, such that execution plans and/or the responses generated for user requests are also more accurate. Additionally, generating content and/or responses understandable to humans has historically been a challenge for machines that do not know the complexities and nuances of language. Thus, by incorporating the LLM, the system is able to provide human-understandable responses, based on the output of executing an execution plan generated by the planner of the system, to thereby provide a more positive interaction between a user which submitted the request and the system.

### Example System for User Request Processing and Answering

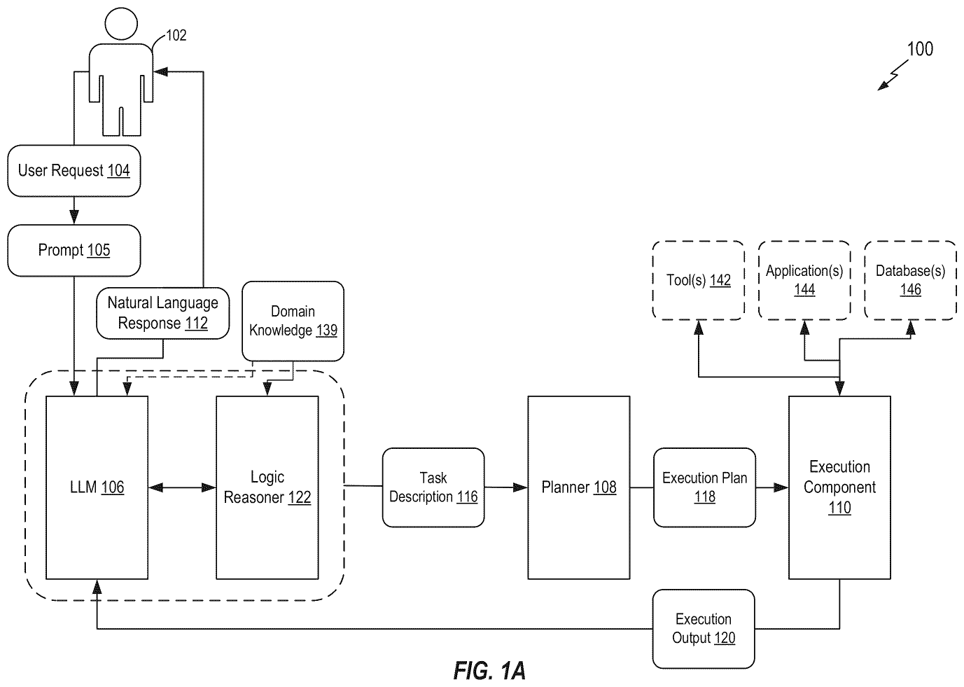

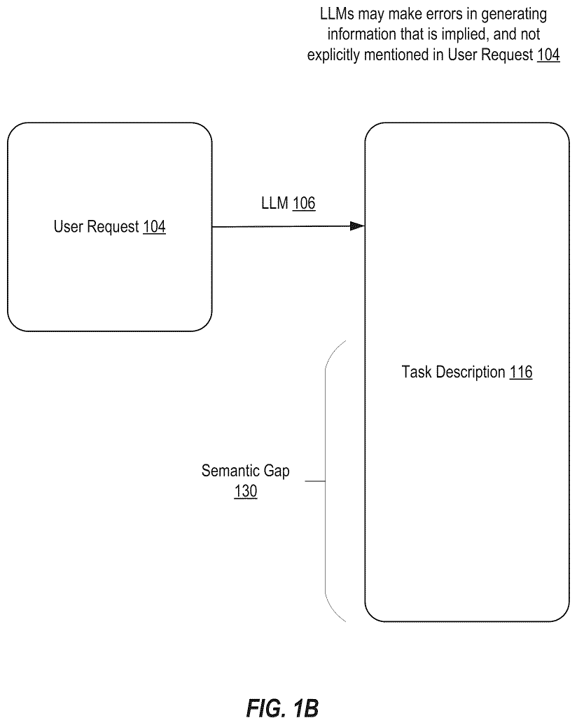

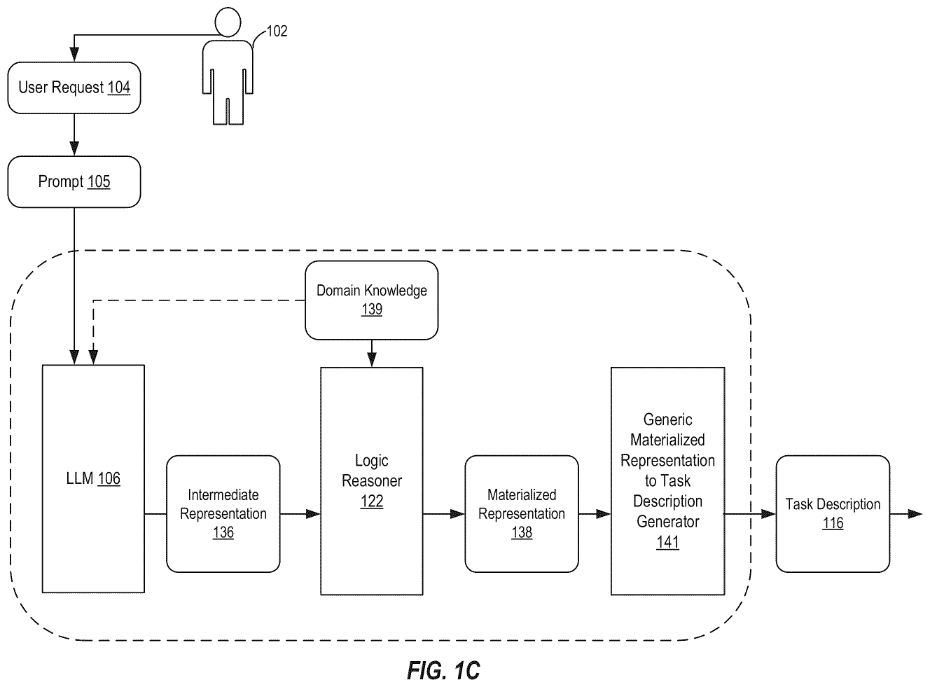

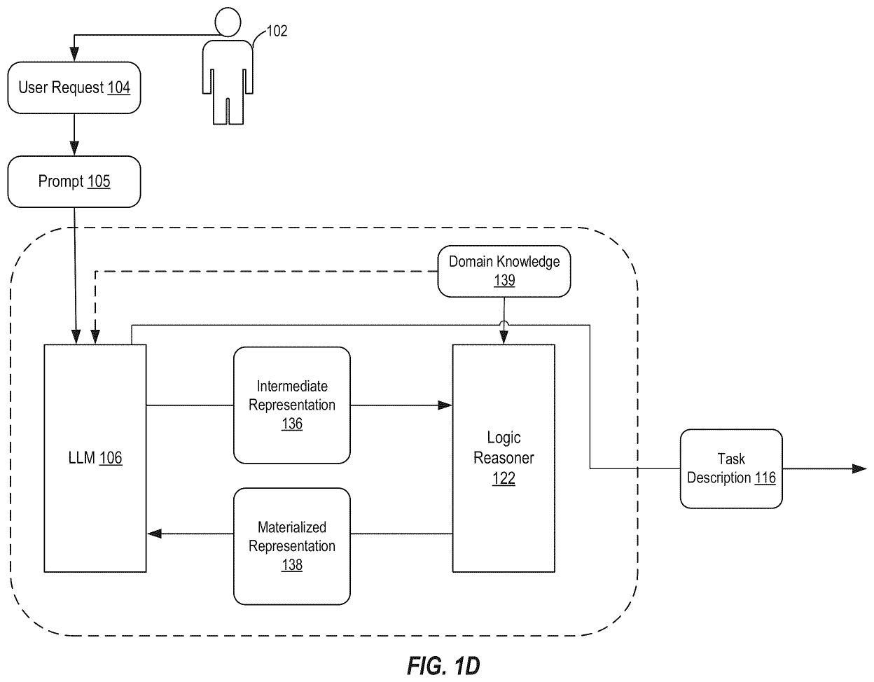

FIG. 1 depicts an example system 100 for processing and answering user requests as planning problems. As illustrated, system 100 includes an LLM 106, a logic reasoner 122, a planner 108, and an execution component 110, which, together, are configured to process and answer a user request 104 (e.g., created by a user 102 and posed in natural language). In some examples described herein, processing and answering user request 104 involves achieving a desired goal state indicated via user request 104, as well as generating a natural language response 112 based on the desired goal state achieved. As described above, a user request and/or a natural language response may consist of terms or phrases spoken normally and/or entered as they might be spoken, without any special format and/or alteration of syntax.

User 102 creates and submits user request 104 to system 100. User 102 may submit the user request 104 through a text interface (e.g., a chat interface), a voice interface (e.g., as through a smart device), and/or the like. In some embodiments, user request 104 requests a state change from an initial state to a desired goal state, where the desired goal state is achieved based on the completion of an information retrieval task (e.g., user request 104 is an “information-seeking user request”). For example, user request 104 may be a question, such as “What was Company X's revenue for the past month compared to the budgeted revenue?” or a statement, such as “Please provide information about student licensing exam passage rates for the past five years.” In some embodiments, user request 104 requests a state change from an initial state to a desired goal state, where the desired goal state is achieved based on the completion of one or more tasks, excluding information retrieval. For example, user request 104 may be a narrative, such as “You control 2 robots. Each robot has a left gripper and a right gripper. There are two rooms and two balls. Robot 1 is in room 1. Robot 2 is in room 1. Ball 2 is in room 1. Ball 1 is in room 1. The robots' grippers are free. Your goal is to transport the balls to their destinations. Ball 1 should be in room 2. Ball 2 should be in room 2.” In this example, the initial state is that all balls and robots are in the room 1, and the robots' grippers are empty. Further, the desired goal state is that all balls are in room 2. In some embodiments, user request 104 requests a state change from an initial state to a desired goal state, where the desired goal state is achieved based on the completion of multiple tasks including information retrieval. Further, user request 104 may be related to a specific user or may be generic. For example, one user request 104 may request that a calendar reminder be created to remind the user 102, who submitted user request 104, about an upcoming town hall meeting, while another user request 104 may request that a calendar reminder be created to remind all users within an organization about the upcoming town hall meeting.

Based on receiving user request 104, system 100 constructs a prompt 105. The prompt 105 may include the user request 104, as well as instructions instructing LLM 106 to generate an intermediate representation of user request 104. Prompt 105 may be provided to LLM 106 to trigger LLM 106 to generate the intermediate representation.

LLM 106 and logic reasoner 122, together, translate user request 104 into a structured input for planner 108 (e.g., at runtime). For example, LLM 106 and logic reasoner 122 may translate user request 104 into a task description 116, such as a task description 116 in PDDL.

As described above, PDDL is the standardized language for expressing planning tasks. PDDL divides the description of a planning task into (1) a domain description and (2) a task description. Everything modeled in PDDL is based on a set of objects (e.g., things in the world that are of interest), where each object belongs to a certain type; however, creating descriptions without any typing is also possible in PDDL. Objects modeled in PDDL may be referred to as a constant or as a variable. When a constant is used, then it is clear exactly which specific object is being referred to. For instance, “yard” and “house” may be constants of type “location,” while “John” may be a constant of type “person.” In contrast, when arguing about any applicable object, variables are used, such as the expression “(?l1?l2—location)” which refers to two arbitrary objects of type “location.”

Predicates apply to a specific type of object, or to all objects. Predicates are either true or false at any point in a planning task. Consider an example predicate in a construction context of is “(walls-built?s-site).” In this example, when the predicate is true for a given construction site, then it is assumed that the site has had walls built for it. When the predicate is false, it can be assumed that the construction site does not have walls built for it yet.

Actions in the domain description define transformations in the state of the world (e.g., from a first state to a second state). This transformation is typically an action that could be performed in the execution of the planning problem, such as picking up an object, constructing something, and/or some other change.

LLM 106 and logic reasoner 122 may translate user request 104 into a task description 116 (e.g., in PDDL) by generating representations of user request 104 (e.g., LLM 106 generates an intermediate representation and logic reasoner 122 generates a materialized representation) prior to generating the task description 116, instead of directly translating user request 104 into the task description 116, to help improve accuracy of the task description generated. In particular, as shown in FIG. 1B, a one-to-one mapping may not exist between information included in user request 104 and information required in task description 116 (e.g., additional information may be needed in task description 116). As such, a semantic gap 130 (e.g., the difference between two descriptions by different linguistic representations) may exist between user request 104 and task description 116. Thus, when LLM 106 is used alone to translate user request 104 directly into a task description 116, LLM 106 may need to infer knowledge that is implicitly stated in user request 104, using rules and/or constraints defined in a domain description, to generate the additional information required for task description 116.

For example, a portion of user request 104 may state “You have 3 intact tires. The intact tires are not inflated.” A task description 116 generated for this user request 104 may need to have one statement per intact tire (e.g., for a total of three statements) indicating that the tire associated with the respective statement is inflated (e.g., for example, when the task description 116 uses PDDL). As such, there may be a one-to-three mapping between the single rule of “The intact tires are not inflated” in user request 104 and the three statements needed to be generated for task description 116. LLM 106, however, may not always make accurate inferences, which may lead to inaccurate information generated for task description 116.

As such, embodiments described herein introduce the use of logic reasoner 122 in combination with LLM 106 to generate task description 116. Specifically, LLM 106 may be prompted to generate an intermediate representation of user request 104 including one or more facts and/or one or more rules (in some cases, the intermediate representation may also be generated based on rules and/or constraints defined in a domain description), and logic reasoner 122 may generate a materialized representation of user request 104 based on the intermediate representation generated by LLM 106. Logic reasoner 122 may derive implicit facts from the set of explicit facts and rules included in the intermediate representation when generating the materialized representation of user request 104 (and/or based on rules and/or constraints defined in a domain description). Different implementations for generating representations (e.g., an intermediate representation and a materialized representation) of user request 104 and using these representations to generate a task description 116 for user request 104 are described below in FIGS. 1C and 1D.

As used herein, a “materialized representation” of a user request may include facts in an appropriate logical language syntax representing the information provided (e.g., directly and/or which is inferable) in the user request and, in some cases, any additional domain knowledge (e.g., domain knowledge applicable for a state change requested via the user request). The facts in a materialized representation may be modeled using a target schema for downstream component(s), such as input for a planner as described in some of the examples described herein.

Logic reasoner 122 may be capable of (1) understanding the semantic relationships between different words and/or phrases included in user request 104, as well as (2) understand the semantics of object types and predicates used in a domain description used to generate task description 116 and (3) understanding the semantics and relationships between concepts, rules, and/or constraints included in the domain description. As such, by using logic reasoner 122 to help make one or more inferences necessary to create task description 116 (e.g., necessary to fill the semantic gap 130), the likelihood of task description 116 including accurate information may be increased. Having an accurate task description 116 may help to ensure that a correct plan and timely response is generated for user request 104, as well as correct action is taken to achieve the desired goal state defined in user request 104.

As shown in a first implementation in FIG. 1C, an intermediate representation 136 of user request 104 is generated by LLM 106. In some cases, LLM 106 is prompted to generate intermediate representation 136 by providing LLM 106 with a prompt 105 (1) including user request 104, (2) including an in-context learning example comprising an example user request (e.g., a previously translated user request) and an example intermediate representation associated with (e.g., previously-generated for) the example user request, and (3) requesting that LLM 106 generate an intermediate representation 136 for user request 104 using the in-context learning example. In some other cases, LLM 106 is prompted to generate an intermediate representation 136 for user request 104 without providing LLM 106 with an in-context learning example in the prompt 105. In such cases, LLM 106 may rely on knowledge of previously-translated user request(s) and their corresponding intermediate representation(s) previously-generated by LLM 106 (e.g., history maintained for LLM 106) to generate an intermediate representation 136 for user request 104. While not having to provide an in-context learning example each time LLM 106 is prompted to generate an intermediate representation 136 saves time and reduces overhead, in some cases, history maintained at LLM 106 for one or more previously-generated prompts may become too large, and thus, using this history to produce an intermediate representation 136 for a new user request may increase processing and response time of LLM 106. Further, in some cases, it may be more beneficial to provide an in-context learning with a same domain description as the current user request 104 for which LLM 106 is expected to generate a task description 116 such that a more accurate task description 116 is generated for the current user request 104.

As described above, system 100 may construct the prompt 105, which may include an in-context learning example (or multiple in-context learning examples). In certain embodiments, in-context learning example(s) included in prompt 105 may be selected from a set of generic in-context examples for all user requests. In certain embodiments, including in-context learning example(s) in prompt 105 may involve dynamically selecting relevant in-context learning example(s) from a pool of in-context learning examples based on a type of user request 104.

In some cases, LLM 106 generates intermediate representation 136 based on domain knowledge 139 (e.g., rules and/or constraints) included in a domain description (shown in FIGS. 1C-1D).

Intermediate representation 136 may include one or more first facts and/or one or more rules extracted from user request 104 (and/or a domain description) and translated into a structured input for use by logic reasoner 122. For example, in some cases, logic reasoner 122 is a programmation en logique (Prolog) logic reasoner; thus, intermediate representation 136 includes one or more facts and/or one or more rules extracted from user request 104 (and/or a domain description) and translated into Prolog language such that intermediate representation 136 may be understood and used by Prolog logic reasoner 122 to generate a materialized representation 138 for user request 104. Though certain examples are discussed with respect to a Prolog logic reasoner 122, the techniques discussed herein are also applicable to other types of logic reasoners, such as answer set programming (ASP) solvers including, for example, Potassco's Clingo™ ASP solver.

Logic reasoner 122 generates a materialized representation 138 of user request 104 based on intermediate representation 136, where materialized representation 138 contains one or more second facts. The one or more second facts may include a subset of the one or more first facts included in intermediate representation 136 and/or one or more facts inferred from first fact(s) included in intermediate representation 136, rule(s) included in intermediate representation 136, and/or domain knowledge 139 (e.g., rules and/or constraints) included in a domain description (not shown in FIGS. 1A-1D) (e.g., domain knowledge 139 as Prolog rules, for example). As such, in some cases, the amount of information included in materialized representation 138 is greater than an amount of information included in intermediate representation 136.

Further, as shown in FIG. 1C, materialized representation 138 may be mapped to task description 116 based on some generic coding (e.g., the code may be generated such that it can apply to any domain). For example, the generic coding may be designed to translate facts included in materialized representation 138 (e.g., in Prolog language) to a specified target language (e.g., PDDL), and use these translated facts to specify objects, the initial state, and the desired goal state, for example, in task description 116. In such implementations, a generic materialized representation to task description generator 141 may be used to perform such translation.

A second implementation for generating task description in PDDL 166 is shown in FIG. 1D. Similar to FIG. 1C, in the second implementation of FIG. 1D, LLM 106 is prompted to generate an intermediate representation 136 for a user request 104, and logic reasoner 122 uses intermediate representation 136 to generate a materialized representation 138. However, unlike FIG. 1C, which uses generic coding to map materialized representation 138 to task description 116, in FIG. 1D, LLM 106 is prompted to perform such mapping and generate task description 116. For example, LLM 106 may be prompted (e.g., with a “task description generation prompt”) to generate task description 116 for materialized representation 138 based on providing LLM 106 with an in-context learning example having an example task description associated with (e.g., previously-generated for) an example user request. The in-context learning example may be associated with a same domain description (e.g., similar domain knowledge) that may be used to translate user request 104 into task description 116.

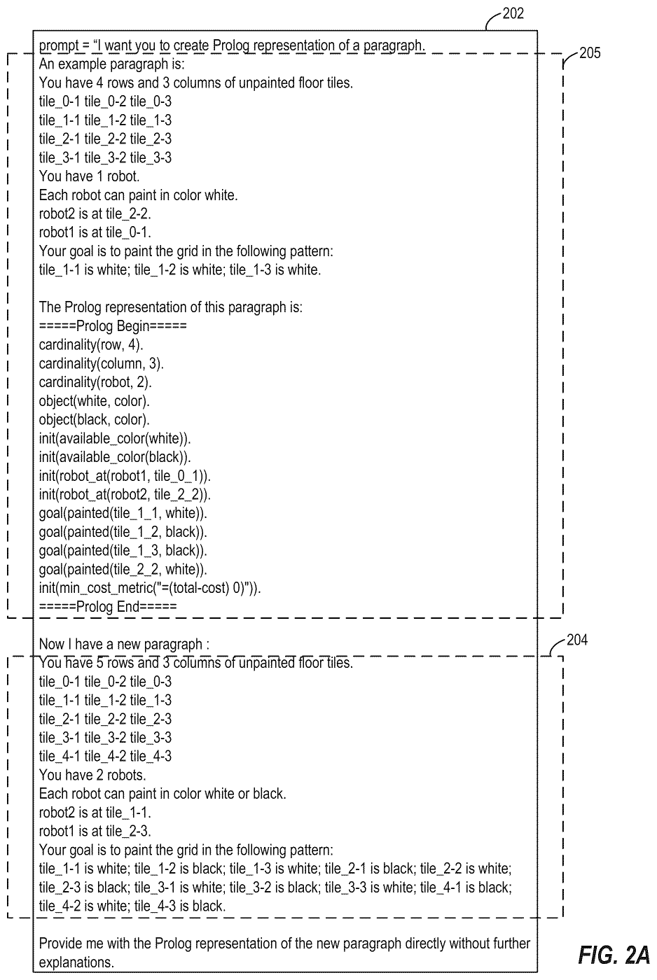

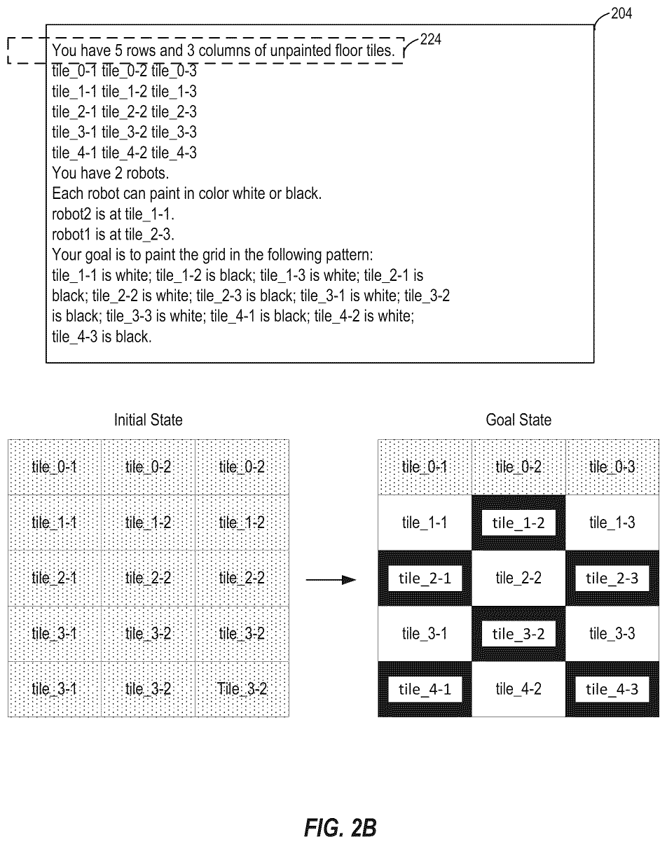

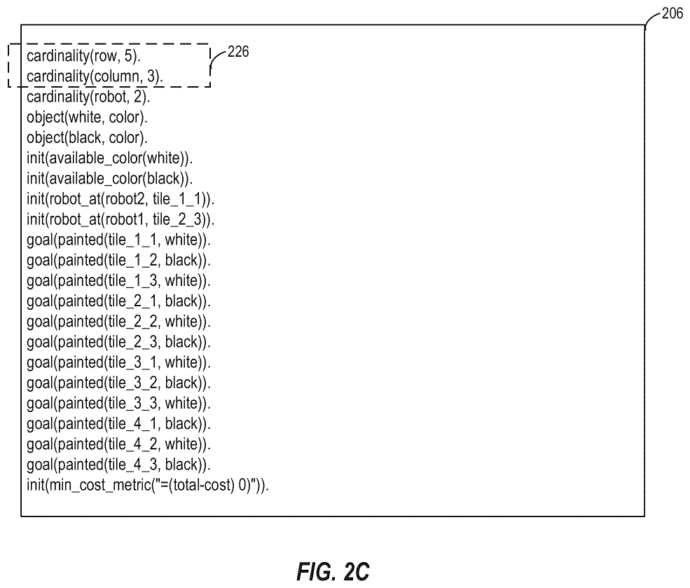

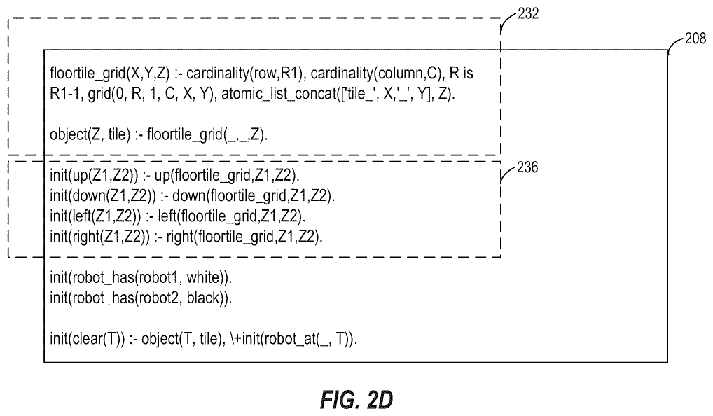

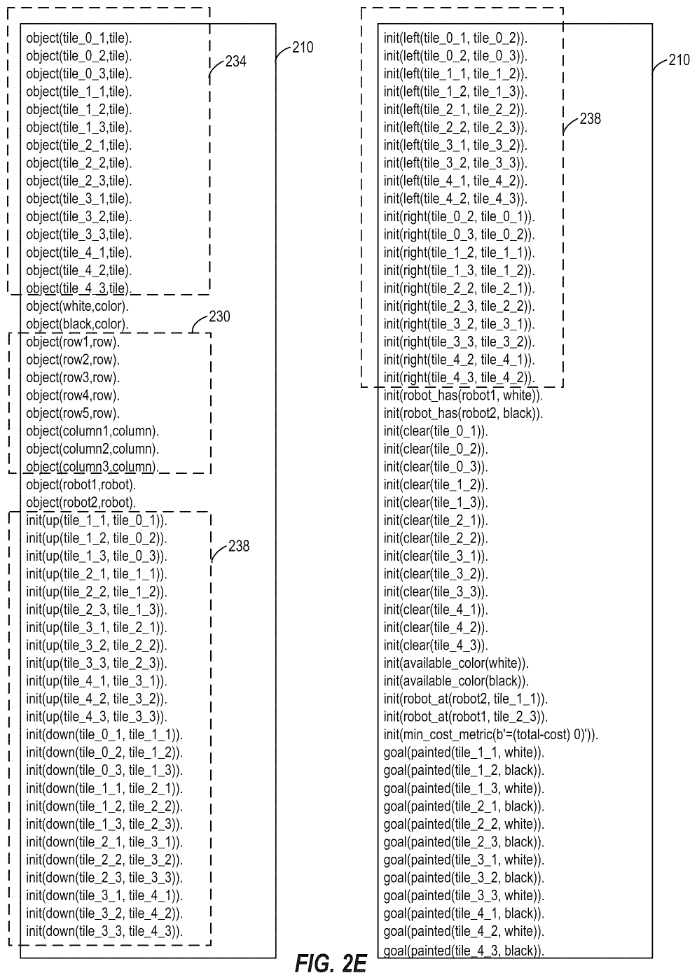

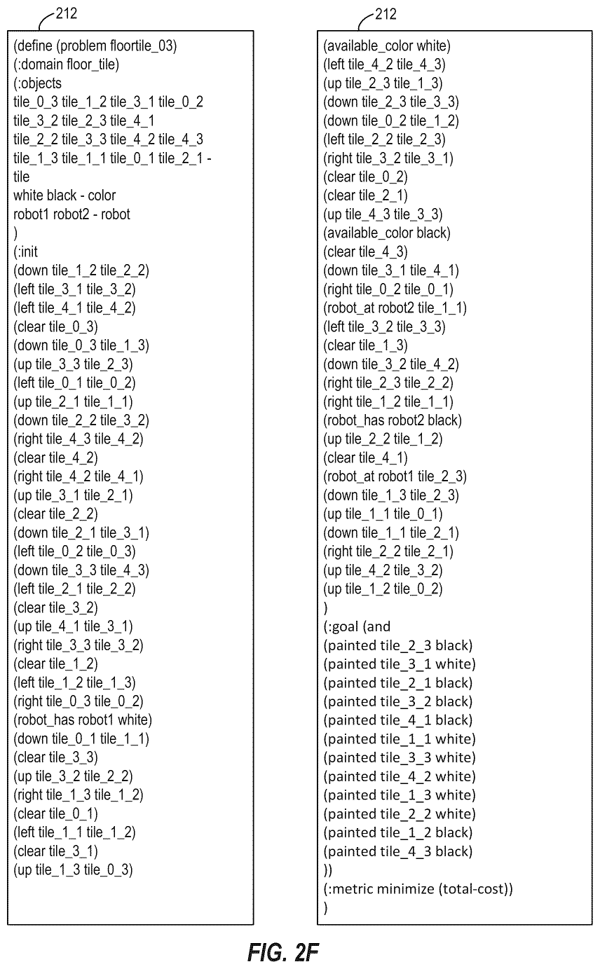

Example task description 116 generation using either the first implementation shown in FIG. 1C or the second implementation shown in FIG. 1D is provided below in FIGS. 2A-2F. For example, FIGS. 2A-2F provide an example inter task description, an example second description, an example domain description, and an example task description in PDDL generated for a prompt using an LLM and a logic reasoner.

Returning to FIG. 1A, planner 108 uses task description 116 generated by LLM 106 and logic reasoner 122, as well as the pre-created domain description (not shown in FIG. 1A), to generate an execution plan 118.

Execution plan 118 includes a sequence of steps used to transform the initial state to the desired goal state originally indicated in user request 104. Steps defined in execution plan 118 may include interfacing with application(s) (e.g., via API(s), using tools, and/or accessing database(s)) specific to one or more organizations. For example, execution plan 118 may include actions domain description, such as: (1) obtain a customer ID, (2) obtain a customer email ID, (3) generate an invoice, (4) send an invoice, etc. These actions may be defined in the pre-created domain description. Planner 108 provides execution plan 118 to execution component 110 to carry out the defined steps.

Execution component 110 executes steps of execution plan 118 in the order in which they are outlined in execution plan 118. Execution component 110 may make API call(s) to one or more applications 144, initiate database query(ies) for one or more databases 146, and/or trigger one or more functions (e.g., via one or more tools 142), as defined by execution plan 118. Essentially, execution component 110 executes the sequence of steps defined in execution plan 118 to transition to the desired goal state. For example, execution component 110 may (1) obtain a customer ID for a customer Jane Doe, (2) obtain an email associated with customer Jane Doe's customer ID, (3) generate an invoice, (4) send an invoice, for example, via email, etc.

Execution of the sequence of steps defined in execution plan 118 results in an execution output 120. Execution output 120 may be a structural representation of the answer, and/or all the information needed to generate a final answer to user request 104. For example, where user request 104 is “Please provide information about student licensing exam passage rates for the past five years,” then the execution output may include an average and/or individual student licensing exam passage rates for years 2018, 2019, 2020, 2021, and 2022. As another example, where user request 104 is “Please send an email reminder to Client Y about our upcoming meeting,” then execution output 120 may be a confirmation message that the requested email was sent.

LLM 106 uses execution output 120 to generate natural language response 112, which is then provided to user 102 in response to user 102 submitting user request 104.

### Example User Request Translation Using Intermediate Representations

FIGS. 2A-2F depict example user request translation using intermediate representations.

For example, FIG. 2A depicts an example prompt 202 that may be provided to an LLM, such as LLM 106 in FIGS. 1A, 1C, and 1D. The prompt 202 may be constructed based on a user request, such as user request 204 shown in FIG. 2A and FIG. 2B, provided by a user. The prompt 202 may be provided to the LLM to instruct the LLM to generate an intermediate representation for the example user request 204. FIG. 2C depicts an example intermediate representation 206 generated for user request 204. FIG. 2D depicts an example domain description 208 that may be used, by a logic reasoner, with the intermediate representation 206 to generate a materialized representation for user request 204, such as materialized representation 210 shown in FIG. 2E. FIG. 2F depicts an example task description 212 (e.g., an example of task description 116 shown in FIGS. 1A, 1C, and 1D) generated for user request 204 based on materialized representation 210. Generation of intermediate representation 206, materialized representation 210, and task description 212 may be performed by an LLM and a logic reasoner of a system, such as LLM 106 and logic reasoner 122 described above with respect to FIGS. 1A, 1C, and 1D.

To begin such user request translation, one or more users (e.g., similar to user 102 in FIG. 1) may create and submit prompt 202 shown in FIG. 2A including user request 204 shown in FIG. 2A and FIG. 2B to the LLM of the system. Prompt 202 shown in FIG. 2A is a request, provided to the LLM, to create an intermediate representation of a user request, and specifically user request 204 shown in FIG. 2A and FIG. 2B, in Prolog language (e.g., based on language “I want you to create Prolog representation”). In this example, prompt 202 further includes an in-context learning example to help facilitate generation of the intermediate representation of user request 204 by the LLM. The in-context learning example provided as part of prompt 202 is shown in FIG. 2A at 205. Based on receiving prompt 202, the LLM is instructed to create an intermediate representation of user request 204 shown in FIG. 2A and FIG. 2B, and the LLM may generate this intermediate representation by learning from the example (e.g., shown at 205) provided in prompt 202.

User request 204 shown in FIG. 2A and FIG. 2B is an example task-oriented user request requesting a state change from an initial state to a desired goal state, based on the completion of one or more tasks. For example, user request 204 is a request to paint one or more tiles in a fifteen tile grid (e.g., five rows and three columns of unpainted tiles as shown by the “Initial State” in FIG. 2B) such that tile_1-1 is painted white, tile_1-2 is painted black, tile_1-3 is painted white, tile_2-1 is painted black, tile_2-2 is painted white, tile_2-3 is painted black, tile_3-1 is painted white, tile_3-2 is painted black, tile_3-3 is painted white, tile_4-1 is painted black, tile_4-2 is painted white, and title_4-3 is painted black (e.g., as shown by the “Goal State” in FIG. 2B).

Based on receiving prompt 202, including the user request 204, the LLM generates intermediate representation 206 shown in FIG. 2C. As described above, intermediate representation 206 includes one or more first facts and/or one or more rules extracted from user request 104 (and/or a domain description, such as domain description 208 shown in FIG. 2D) and translated to a target language specified in prompt 202. For example, because prompt 202 instructed the LLM to generate a Prolog representation of user request 204, the intermediate representation 206 includes first fact(s) and/or rule(s) in the Prolog language. As an illustrative example, user request 204 includes statement 224 stating “You have 5 rows and 3 columns of unpainted floor tiles.” The LLM (e.g., receiving prompt 202 having user request 204) extracts this language from user request 204, translates this language into the Prolog language, and creates two facts (e.g., shown as facts 226 that state “cardinality (row, 5)” and “cardinality (column, 3)”) in intermediate representation 206 shown in FIG. 2C. As such, creation of intermediate representation 206 causes the LLM to create at least two facts in intermediate representation 206 from a single statement 224 included in user request 204. Other facts and/or rules are also created in intermediate representation 206 for statement 224. Similar extraction and translation is also performed for other statements included in user request 204 to generate the remainder of intermediate representation 206.

After generation of intermediate representation 206, a logic reasoner generates materialized representation 210 (e.g., shown in FIG. 2E) based on intermediate representation 206 shown in FIG. 2C and domain description 208 (e.g., in Prolog) shown in FIG. 2D. Domain description 208 shown in FIG. 2D may have existed prior to the LLM receiving prompt 202 and user request 204.

Materialized representation 210 shown in FIG. 2E includes one or more second facts (e.g., but does not include any rules) in the Prolog language. As described above, the one or more second facts included in materialized representation 210 may include a subset (e.g., one or more) of the first fact(s) included in intermediate representation 206. Further, the one or more second facts included in materialized representation 210 may include one or more facts inferred from first fact(s) included in intermediate representation 206, one or more facts inferred from rule(s) included in intermediate representation 206, and/or one or more facts inferred from domain knowledge (e.g., rules and/or constraints) included in domain description 208. As an illustrative example, second facts included in materialized representation 210 include facts 230 generated based on, at least, facts 226 in intermediate representation 206. Specifically, facts 226 (e.g., two line items) included in intermediate representation 206 are expanded to eight line items (e.g., “object (row1, row),” “object (row2, row),” “object (row3, row),” “object (row4, row),” “object (row5, row),” “object (column1, column),” “object (column2, column),” and “object (column3, column)” which make up facts 230 in materialized representation 210.

As another illustrative example, two rules 232 in domain description 208 (e.g., in FIG. 2D) are used to generate facts 234 in materialized representation 210 (e.g., in FIG. 2E). Specifically, a first of the two rules 232 indicates that for each row, column combination (R,C), a fact “floortile_grid(R,C, tile_R_C)” is to be generated for materialized representation 210. Further, a second of the two rules 232 indicates a second rule “object(Z, tile):−floortile_grid(_,_,Z)” for generating tile objects for the floortile_grid facts created based on the first of the two rules 232.

As another illustrative example, rules 236 shown in domain description 208 in FIG. 2D are used to create facts 238 shown in materialized representation 210 in FIG. 2E.

Materialized representation 210 is then used to generate task description 212 in FIG. 2F. As described above with respect to FIGS. 1C and 1D, respectively, materialized representation 210 may be mapped to task description 212 based on some generic coding, or the LLM may again be prompted to generate task description 212 based on the materialized representation 210 generated for user request 204. Task description 212 includes objects with their identified object type (e.g., from domain description 208), an initial state (e.g., shown as “init”), and a desired goal state (e.g., shown as “goal”). In certain aspects, task description 212 may comprise a PDDL task description.

### Example Method for User Request Translation

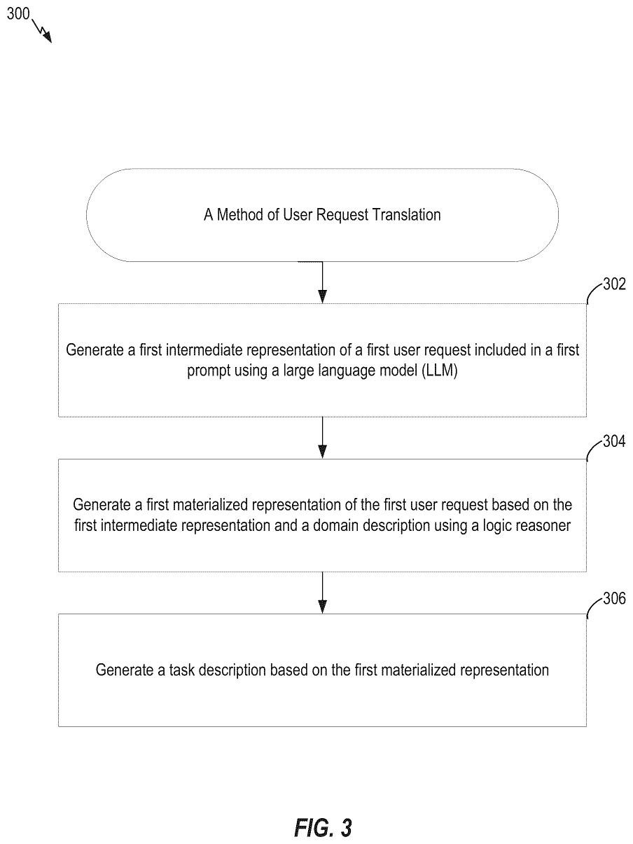

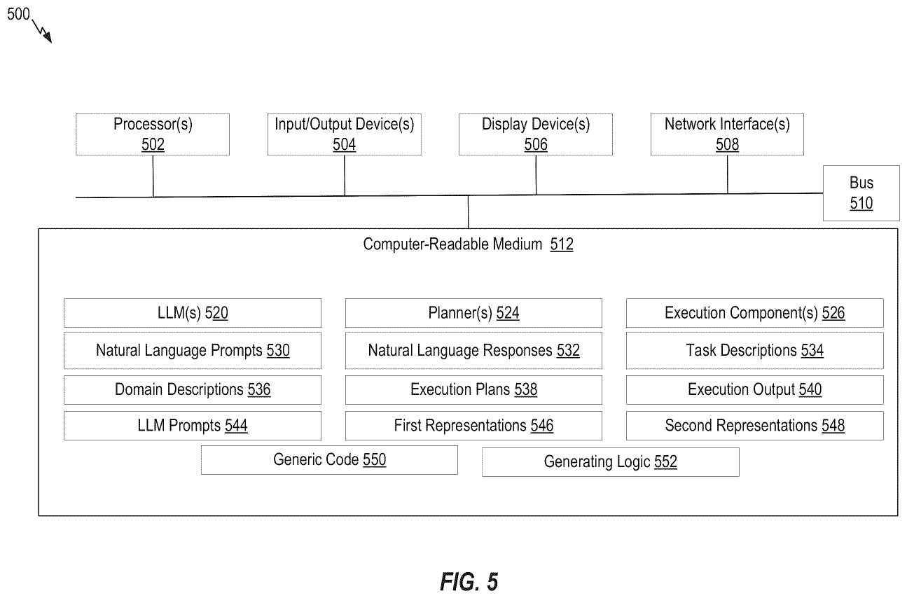

FIG. 3 depicts an example method 300 for user request translation. Method 300 may be performed by one or more processor(s) of a computing device, such as processor(s) 502 of processing system 500 described below with respect FIG. 5.

Method 300 begins, at step 302, with generating a first intermediate representation of a first user request included in a first prompt using a LLM (e.g., such as LLM 106 of FIGS. 1A, 1C, and 1D). The first user request may request a state change from an initial state to a desired goal state. Further, the first intermediate representation may include at least one of: one or more first facts, or one or more rules in a declarative language.

Method 300 proceeds, at step 304, generating a first materialized representation of the first user request based on the first intermediate representation and a domain description using a logic reasoner (e.g., such as logic reasoner 122 of FIGS. 1A, 1C, and 1D). The first materialized representation may include one or more second facts in the declarative language. The one or more second facts may include a subset of the one or more first facts and one or more inferred facts.

Method 300 proceeds, at step 306, with generating a task description based on the first materialized representation. The task description may include structured input for a planner.

In certain aspects, the first prompt further comprises an in-context learning example comprising: an example user request, and an example intermediate representation generated for example user request in the declarative language; and the first intermediate representation of the first user request is generated based on the example user request and the example intermediate representation generated for the example user request.

In certain aspects, method 300 further includes generating a second intermediate representation of a second user request included in a second prompt using the LLM, wherein the second prompt does not include another in-context learning example, and the second intermediate representation of the second user request is generated based on the example user request, the example intermediate representation generated for the example user request, the first user request, and the first intermediate representation of the first user request.

In certain aspects, the LLM generates the task description based on the first materialized representation of the first user request.

In certain aspects, generating, by the LLM, the task description based on the first materialized representation comprises generating the task description as a response to a task description generation prompt instructing the LLM to generate the task description based on the first materialized representation, the task description generation prompt comprising an in-context learning example comprising: an example materialized representation of an example user request, and an example task description previously generated for the example materialized representation of the example user request.

In certain aspects, generating the first intermediate representation of the first user request is generated based on a domain description.

In certain aspects, the first intermediate representation comprises a translation of the first user request in Programmation en logique (Prolog) language; the logic reasoner comprises a Prolog reasoner; and the first materialized representation comprises a translation of the first intermediate representation in the Prolog language.

In certain aspects, the task description is generated in a planning domain definition language (PDDL), a structured query language (SQL), Python code, or SPARQL protocol and resource description framework (RDF) query language (SPARQL).

In certain aspects, the desired goal state requested by the first user request comprises: a possession of information; or a completion of one or more tasks excluding information retrieval.

Note that FIG. 3 is just one example of a method, and other methods including fewer, additional, or alternative steps are possible consistent with this disclosure.

### Example Method for Plan Generation

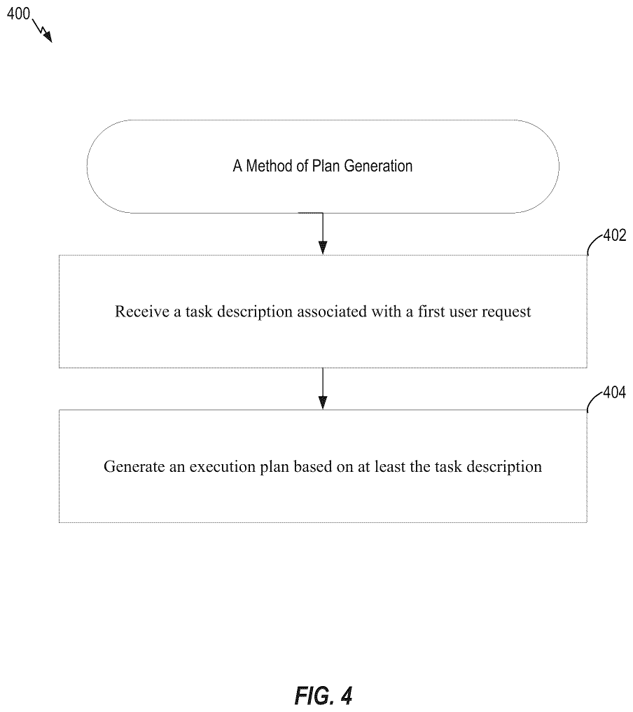

FIG. 4 depicts an example method 400 for plan generation. Method 400 may be performed by one or more processor(s) of a computing device, such as processor(s) 502 of processing system 500 described below with respect FIG. 5.

Method 400 begins, at step 402, with receiving a task description associated with a first user request. The first user request may request a state change from an initial state to a desired goal state. The task description may comprise structured input for a planner and be based on a materialized representation. The materialized representation may comprise one or first facts in a declarative language that are associated with an intermediate representation of the first user request. The intermediate representation may include at least one of: one or more second facts, or one or more rules in a declarative language.

Method 400 proceeds, at step 404, with generating an execution plan based on at least the task description. The execution plan may comprise a sequence of steps used to transform the initial state to the desired goal state.

In certain aspects, the one or more first facts comprise at least one of: a subset of the one or more second facts; or one or more third facts inferred from at least one of the one or more second facts or the one or more rules in the declarative language.

In certain aspects, the materialized representation is further based on a domain description.

In certain aspects, the intermediate representation of the first user request is based on a domain description.

In certain aspects, the intermediate representation comprises a translation of the first user request in Programmation en logique (Prolog) language; and the materialized representation comprises a translation of the intermediate representation in the Prolog language.

In certain aspects, the task description comprises: a planning domain definition language (PDDL); a structured query language (SQL); Python code; or SPARQL protocol and resource description framework (RDF) query language (SPARQL).

In certain aspects, the desired goal state requested by the first user request comprises: a possession of information; or a completion of one or more tasks excluding information retrieval

Note that FIG. 4 is just one example of a method, and other methods including fewer, additional, or alternative steps are possible consistent with this disclosure.

### Example Processing System for User Request Processing and Answering

FIG. 5 depicts an example processing system 500 configured to perform various aspects described herein, including, for example, method 300 as described above with respect to FIG. 3 and/or method 400 as described above with respect to FIG. 4.

Processing system 500 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 500 includes one or more processors 502, one or more input/output devices 504, one or more display devices 506, one or more network interfaces 508 through which processing system 500 is connected to one or more networks (e.g., a local network, an intranet, the Internet, or any other group of processing systems communicatively connected to each other), and computer-readable medium 512. In the depicted example, the aforementioned components are coupled by a bus 510, which may generally be configured for data exchange amongst the components. Bus 510 may be representative of multiple buses, while only one is depicted for simplicity.

Processor(s) 502 are generally configured to retrieve and execute instructions stored in one or more memories, including local memories like computer-readable medium 512, as well as remote memories and data stores. Similarly, processor(s) 502 are configured to store application data residing in local memories like the computer-readable medium 512, as well as remote memories and data stores. More generally, bus 510 is configured to transmit programming instructions and application data among the processor(s) 502, display device(s) 506, network interface(s) 508, and/or computer-readable medium 512. In certain embodiments, processor(s) 502 are representative of a one or more central processing units (CPUs), graphics processing unit (GPUs), tensor processing unit (TPUs), accelerators, and other processing devices.

Input/output device(s) 504 may include any device, mechanism, system, interactive display, and/or various other hardware and software components for communicating information between processing system 500 and a user of processing system 500. For example, input/output device(s) 504 may include input hardware, such as a keyboard, touch screen, button, microphone, speaker, and/or other device for receiving inputs from the user and sending outputs to the user.

Display device(s) 506 may generally include any sort of device configured to display data, information, graphics, user interface elements, and the like to a user. For example, display device(s) 506 may include internal and external displays such as an internal display of a tablet computer or an external display for a server computer or a projector. Display device(s) 506 may further include displays for devices, such as augmented, virtual, and/or extended reality devices. In various embodiments, display device(s) 516 may be configured to display a graphical user interface.

Network interface(s) 508 provide processing system 500 with access to external networks and thereby to external processing systems. Network interface(s) 508 can generally be any hardware and/or software capable of transmitting and/or receiving data via a wired or wireless network connection. Accordingly, network interface(s) 508 can include a communication transceiver for sending and/or receiving any wired and/or wireless communication.

Computer-readable medium 512 may be a volatile memory, such as a random access memory (RAM), or a nonvolatile memory, such as nonvolatile random access memory (NVRAM), or the like. In this example, computer-readable medium 512 includes LLM(s) 520, planner(s) 524, execution component(s) 526, natural language prompts 530, natural language responses 532, task descriptions 534, domain descriptions 536, execution plans 538, execution output 540, LLM prompts 544, first representations 546, second representations 548, generic code 550, and generating logic 552.

In some embodiments, generating logic 552 includes logic for generating an intermediate representation of a user request using a LLM.

In some embodiments, generating logic 552 includes logic for generating a materialized representation of a user request based on an intermediate representation generated for the user request and a domain description using a logic reasoner.

In some embodiments, generating logic 552 includes logic for generating a task description based on a materialized representation.

In some embodiments, generating logic 552 includes logic for generating a task description as a response to a task description generation prompt instructing an LLM to generate the task description based on a materialized representation.

### Example Clauses

Implementation examples are described in the following numbered clauses:

Clause 1: A method of user request translation, comprising: generating a first intermediate representation of a first user request included in a first prompt using a large language model (LLM), wherein the first user request requests a state change from an initial state to a desired goal state, and wherein the first intermediate representation comprises at least one of: one or more first facts, or one or more rules in a declarative language; generating a first materialized representation of the first user request based on the first intermediate representation and a domain description using a logic reasoner, wherein the first materialized representation comprises one or more second facts in the declarative language, and wherein the one or more second facts comprise a subset of the one or more first facts and one or more inferred facts; and generating a task description based on the first materialized representation, wherein the task description comprises structured input for a planner.

Clause 2: The method of Clause 1, wherein: the first prompt further comprises an in-context learning example comprising: an example user request, and an example intermediate representation generated for example user request in the declarative language; and the first intermediate representation of the first user request is generated based on the example user request and the example intermediate representation generated for the example user request.

Clause 3: The method of Clause 2, further comprising generating a second intermediate representation of a second user request included in a second prompt using the LLM, wherein the second prompt does not include another in-context learning example, and the second intermediate representation of the second user request is generated based on the example user request, the example intermediate representation generated for the example user request, the first user request, and the first intermediate representation of the first user request.

Clause 4: The method of any one of Clauses 1-3, wherein the LLM generates the task description based on the first materialized representation of the first user request.

Clause 5: The method of Clause 4, wherein generating, by the LLM, the task description based on the first materialized representation comprises generating the task description as a response to a task description generation prompt instructing the LLM to generate the task description based on the first materialized representation, the task description generation prompt comprising an in-context learning example comprising: an example materialized representation of an example user request, and an example task description previously generated for the example materialized representation of the example user request.

Clause 6: The method of any one of Clauses 1-5, wherein generating the first intermediate representation of the first user request is generated based on a domain description.

Clause 7: The method of any one of Clauses 1-6, wherein: the first intermediate representation comprises a translation of the first user request in Programmation en logique (Prolog) language; the logic reasoner comprises a Prolog reasoner; and the first materialized representation comprises a translation of the first intermediate representation in the Prolog language.

Clause 8: The method of any one of Clauses 1-7, wherein the task description is generated in a planning domain definition language (PDDL), a structured query language (SQL), Python code, or SPARQL protocol and resource description framework (RDF) query language (SPARQL).

Clause 9: The method of any one of Clauses 1-8, wherein the desired goal state requested by the first user request comprises: a possession of information; or a completion of one or more tasks excluding information retrieval.

Clause 10: A method of plan generation, comprising: receiving a task description associated with a first user request, wherein: the first user request requests a state change from an initial state to a desired goal state, and the task description comprises structured input for a planner and is based on a materialized representation comprising one or first facts in a declarative language that are associated with an intermediate representation of the first user request comprising at least one of: one or more second facts, or one or more rules in the declarative language; and generating an execution plan based on at least the task description, wherein the execution plan comprises a sequence of steps used to transform the initial state to the desired goal state.

Clause 11: The method of Clause 10, wherein the one or more first facts comprise at least one of: a subset of the one or more second facts; or one or more third facts inferred from at least one of the one or more second facts or the one or more rules in the declarative language.

Clause 12: The method of any one of Clauses 10-11, wherein the materialized representation is further based on a domain description.

Clause 13: The method of any one of Clauses 10-12, wherein the intermediate representation of the first user request is based on a domain description.

Clause 14: The method of any one of Clauses 10-13, wherein: the intermediate representation comprises a translation of the first user request in Programmation en logique (Prolog) language; and the materialized representation comprises a translation of the intermediate representation in the Prolog language.

Clause 15: The method of any one of Clauses 10-14, wherein the task description comprises: a planning domain definition language (PDDL); a structured query language (SQL); Python code; or SPARQL protocol and resource description framework (RDF) query language (SPARQL).

Clause 16: The method of any one of Clauses 10-15, wherein the desired goal state requested by the first user request comprises: a possession of information; or a completion of one or more tasks excluding information retrieval.

Clause 17: A processing system, comprising: one or more memories comprising processor-executable instructions; and one or more processors configured to execute the processor-executable instructions and cause the processing system to perform a method in accordance with any one of Clauses 1-16.

Clause 18: A processing system, comprising means for performing a method in accordance with any one of Clauses 1-16.

Clause 19: A non-transitory computer-readable medium storing program code for causing a processing system to perform the steps of any one of Clauses 1-16.

Clause 20: A computer program product embodied on a computer-readable storage medium comprising code for performing a method in accordance with any one of Clauses 1-16.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of user request translation, comprising:
generating a first intermediate representation of a first user request included in a first prompt using a large language model (LLM), wherein the first user request requests a state change from an initial state to a desired goal state, and wherein the first intermediate representation comprises at least one of:
one or more first facts, or
one or more rules in a declarative language;
generating a first materialized representation of the first user request based on the first intermediate representation and a domain description using a logic reasoner, wherein the first materialized representation comprises one or more second facts in the declarative language, and wherein the one or more second facts comprise at least one of a subset of the one or more first facts or one or more inferred facts; and
generating a task description based on the first materialized representation, wherein the task description comprises structured input for a planner.

2. The method of claim 1, wherein:
the first prompt further comprises an in-context learning example comprising:
an example user request, and
an example intermediate representation generated for the example user request in the declarative language; and
the first intermediate representation of the first user request is generated based on the example user request and the example intermediate representation generated for the example user request.

3. The method of claim 2, further comprising generating a second intermediate representation of a second user request included in a second prompt using the LLM, wherein the second prompt does not include another in-context learning example, and the second intermediate representation of the second user request is generated based on the example user request, the example intermediate representation generated for the example user request, the first user request, and the first intermediate representation of the first user request.

4. The method of claim 1, wherein the LLM generates the task description based on the first materialized representation of the first user request.

5. The method of claim 4, wherein generating, by the LLM, the task description based on the first materialized representation comprises generating the task description as a response to a task description generation prompt instructing the LLM to generate the task description based on the first materialized representation, the task description generation prompt comprising an in-context learning example comprising:
an example materialized representation of an example user request, and
an example task description previously generated for the example materialized representation of the example user request.

6. The method of claim 1, wherein generating the first intermediate representation of the first user request is generated based on the domain description.

7. The method of claim 1, wherein:
the first intermediate representation comprises a translation of the first user request in Programmation en logique (Prolog) language;
the logic reasoner comprises a Prolog logic reasoner; and
the first materialized representation comprises a translation of the first intermediate representation in the Prolog language.

8. The method of claim 1, wherein the task description is generated in:
a planning domain definition language (PDDL);
a structured query language (SQL);
Python code; or
SPARQL protocol and resource description framework (RDF) query language (SPARQL).

9. The method of claim 1, wherein the desired goal state requested by the first user request comprises:
a possession of information; or
a completion of one or more tasks excluding information retrieval.

10. A method of plan generation, comprising:
receiving a task description associated with a first user request, wherein:
the first user request requests a state change from an initial state to a desired goal state, and
the task description comprises structured input for a planner and is based on a materialized representation comprising one or first facts in a declarative language that are associated with an intermediate representation of the first user request comprising at least one of:
one or more second facts, or
one or more rules in the declarative language; and
generating an execution plan based on at least the task description, wherein the execution plan comprises a sequence of steps used to transform the initial state to the desired goal state.

11. The method of claim 10, wherein the one or more first facts comprise at least one of:
a subset of the one or more second facts; or
one or more third facts inferred from at least one of the one or more second facts or the one or more rules in the declarative language.

12. The method of claim 10, wherein the materialized representation is further based on a domain description.

13. The method of claim 10, wherein the intermediate representation of the first user request is based on a domain description.

14. The method of claim 10, wherein:
the intermediate representation comprises a translation of the first user request in Programmation en logique (Prolog) language; and
the materialized representation comprises a translation of the intermediate representation in the Prolog language.

15. The method of claim 10, wherein the task description comprises:
a planning domain definition language (PDDL);
a structured query language (SQL);
Python code; or
SPARQL protocol and resource description framework (RDF) query language (SPARQL).

16. The method of claim 10, wherein the desired goal state requested by the first user request comprises:
a possession of information; or
a completion of one or more tasks excluding information retrieval.

17. A processing system, comprising:
a memory comprising computer-executable instructions; and
a processor configured to execute the computer-executable instructions and cause the processing system to:
generate a first intermediate representation of a first user request included in a first prompt using a large language model (LLM), wherein the first user request requests a state change from an initial state to a desired goal state, and wherein the first intermediate representation comprises at least one of:
one or more first facts, or
one or more rules in a declarative language;
generate a first materialized representation of the first user request based on the first intermediate representation and a domain description using a logic reasoner, wherein the first materialized representation comprises one or more second facts in the declarative language, and wherein the one or more second facts comprise at least one of a subset of the one or more first facts or one or more inferred facts; and
generate a task description based on the first materialized representation, wherein the task description comprises structured input for a planner.

18. The processing system of claim 17, wherein:
the first prompt further comprises an in-context learning example comprising:
an example user request, and
an example intermediate representation generated for the example user request in the declarative language; and
the first intermediate representation of the first user request is generated based on the example user request and the example intermediate representation generated for the example user request.

19. The processing system of claim 18, wherein the processor is configured to execute the computer-executable instructions and further cause the processing system to:
generate a second intermediate representation of a second user request included in a second prompt using the LLM, wherein the second prompt does not include another in-context learning example, and the second intermediate representation of the second user request is generated based on the example user request, the example intermediate representation generated for the example user request, the first user request, and the first intermediate representation of the first user request.

20. The processing system of claim 17, wherein the LLM generates the task description based on the first materialized representation of the first user request.
